(19) United States
(12) Patent Application Publication
(10) Pub. No.: US 2022/0067679 A1
(43) Pub. Date: Mar. 3, 2022

(54) COMMUNICATION SYSTEM, COMPUTERIZED METHOD AND AND COMPUTER PROGRAMS FOR ORDER-SHARING AMONG A PLURALITY OF CUSTOMERS AT A COMMERCIAL VENUE

(71) Applicant: PEJ AB, Malmö (SE)

(72) Inventors: Victor SANDBERG, Malmö (SE); Marcus JOHANSSON, Lund (SE)

(73) Assignee: PEJ AB, Malmö (SE)

(21) Appl. No.: 17/413,707

(22) PCT Filed: Dec. 12, 2019
(86) PCT No.: PCT/SE2019/051273

§ 371 Date: Jun. 14, 2021

(30) Foreign Application Priority Data
Dec. 12, 2018 (SE) 1851556-9

(51) Int. Cl. G06Q 20/10; G06Q 20/32; G06Q 20/14; G06Q 30/06

(52) U.S. Cl. CPC G06Q 20/102; G06Q 30/0635; G06Q 20/145; G06Q 20/3276

(57) ABSTRACT

A communication system (100) for order sharing among a plurality of customers (110) at a commercial venue (101) includes sewer-side functionality (SSF) and a plurality of customer mobile computing devices (CMCD) for use by the customers. The server-side functionality manages a digital order (DO) and provides a network communication channel (NCC) for the digital order. The customer mobile computing devices communicate (140) with the server-side functionality using the network communication channel. The communication includes a) the sewer-side functionality collectively sharing the digital order with the customer mobile computing devices. The communication also includes b) an individual customer mobile computing device (CMCD i) requesting partial settlement of the digital order, where the partial settlement relates to a partial payment of less than a total order value of all unsettled order items of the digital order, or payment of one or more, but less than all, unsettled order items of the digital order. The communication further includes c) the customer mobile computing devices receiving a collective update of the digital order from the sewer-side functionality to reflect the partial settlement.

### TECHNICAL FIELD

The present invention generally relates to the field of mobile commerce, and more particularly to a communication system, a computerized method and computer programs for order sharing among a plurality of customers at a commercial venue.

### BACKGROUND

Mobile commerce is rapidly growing. Mobile devices have been frequently used for quite some years already by people wishing to shop on the Internet. In these situations, the mobile devices are used both as tools for selecting and ordering goods or services, and as tools for paying for the ordered goods or services.

When it comes to real-life commerce (i.e. people buying goods or services from merchants at a physical point of sale or pick-up point at a shop, supermarket, service provider, event venue, etc), society has been a bit more conservative. Conventionally, a customer “manually” places an order either by bringing order items collected during a stroll in the premises (e.g. groceries, clothing) to a physical point of sale or pick-up counter, or by telling a shop assistant at the point of sale or pick-up counter about the order items he or she wishes to purchase. The purchase is then paid for by cash or credit card at the point of sale or pick-up counter.

FIG. 1A illustrates an area of particular interest for the present invention, being the kind of real-life commerce which takes place when a group 10 of customers 10₁-10ₙ are joining in to enjoy the services provided at a commercial venue 1 such as, for instance, a restaurant, bar, club, café, sport arena, concerts hall, theatre or cinema. The group 10 of customers may be family, friends, business colleagues, team mates, etc., and the services may, for instance, involve having supper, lunch, breakfast, coffee break, snacks or refreshments together in the group 10.

The group 10 is typically serviced at a spot 11, such as a table, in the venue 1 by a merchant 12 in the form of a waiter/waitress or a bartender. The merchant 12 collects the orderings from the individual customers 10₁-10ₙ of the group 10 and then uses a merchant computing device MCD to enter the orderings as order items of one or more digital orders. This is made for the purpose of facilitating the further processing of the orderings, including subsequent payment for the orderings, which may relate to articles or services, or a combination thereof, consumed by the group 10 of customers.

If each individual customer, or different subgroups of the group 10 of customers, wants to have its own bill, the merchant 12 will have to generate separate digital orders DO₁-DOₘ to handle the orderings from the customers 10₁-10ₙ. This is seen in FIG. 1A. The digital orders DO₁-DOₘ may be stored locally in or at the merchant computing device MCD, or at a cloud resource or remote server accessible over one or more communication network(s) 20. Having separate bills might have some benefits to the customers, since it facilitates individual settlement (payment) of the order items that each individual has ordered. However, this also has some disadvantages since it gives rise to overhead work for the merchant and may delay the ordering stage and, as a result, also the deliveries of the orderings to the customers. Moreover, treating the orders separately already at the ordering stage might negate the sensation for the customers 10₁-10ₙ of being a single, unite group 10.

Therefore, it is desired to allow a group of customers to share a single order. In such a case, as is seen in FIG. 1B, the merchant 12 generates a single digital order DO by the merchant computing device MCD, and adds the order items from all individual customers 10₁-10ₙ of the group 10 to this single digital order DO which is common to all the customers 10₁-10ₙ. Similar to FIG. 1A, the single digital order DO may be stored locally in or at the merchant computing device MCD, or at a cloud resource or remote server accessible over the communication network(s) 20.

The prior art approach seen in FIG. 1B has some remaining deficiencies that the present invention seeks to remedy or at least mitigate.

One deficiency of the prior art is that even though the single digital order DO might serve its purpose at the actual ordering stage for the customers 10₁-10ₙ to enjoy a sensation of belonging to a single, unite group 10, the sensation does not extend to subsequent stages of the visit to the venue 1. For instance, if more order items are added to the digital order at a later stage (like a second round of beer, or ordering of desserts), all customers 10₁-10ₙ may no longer be aware of the exact contents of the digital order. This is because the digital order DO is kept solely at the merchant computing device MCD side and is not accessible to the customers 10₁-10ₙ, unless they specifically ask the merchant 12 about its current contents. Some of the customers 10₁-10ₙ may not be present at the table 11 when such additional orderings are made (they may, for instance, have departed temporarily to visit the restroom, make a phone call or have a bit of fresh air outside of the venue 1), and may therefore not be aware of the additional orderings. The situation is similar if some individual customers 10₁-10ₙ join in at the venue 1 later than the rest of the group.

Another deficiency of the prior art appears at the settlement/payment stage in cases when the single digital order DO is to be settled by more than one person. Settlement will typically involve cash payment, or credit card payment to a payment processor PP accessible over the communication network(s) 20. If the bill for the digital order DO is to be split between some or all of the customers 10₁-10ₙ, the merchant 12 will have to ask the group 10, order item by order item, who among the customers 10₁-10ₙ that is to pay for that part of the digital order DO. Alternatively, the merchant 12 will have to ask the customers 10₁-10ₙ of the group 10, member by member, what order items of the digital order DO that each customer shall pay for. Substantive manual labor and time are required to settle an order in either of these ways.

The problem is accentuated if the digital order DO is not to be settled in its entirety at the same time. Quite commonly, the individuals of the group 10 of customers at the commercial venue 1 may want to leave the venue at different times, and therefore also settle their respective parts of the digital order at different times. This makes it even harder for every (remaining) customer 10₁-10ₙ of the group 10 to keep updated on the current contents of the digital order DO, and what parts remain unsettled.

The present inventors have realized that improvements can be made in these regards.

### SUMMARY

It is accordingly an object of the invention to remedy or at least mitigate one or more of the deficiency discussed above.

A first aspect of the present invention is a communication system for order sharing among a plurality of customers at a commercial venue. The communication system comprises server-side functionality and a plurality of customer mobile computing devices for use by the plurality of customers.

The server-side functionality is configured to manage a digital order. Moreover, the server-side functionality is configured to provide a network communication channel for the digital order.

The customer mobile computing devices are configured for communication with the server-side functionality using the network communication channel. The communication includes:
a) the server-side functionality collectively sharing the digital order with the plurality of customer mobile computing devices;
b) an individual customer mobile computing device requesting partial settlement of the digital order, where the partial settlement relates to any of:
   a partial payment of less than a total order value of all unsettled order items of the digital order, or
   payment of one or more, but less than all, unsettled order items of the digital order; and
c) the customer mobile computing devices receiving a collective update of the digital order from the server-side functionality to reflect the partial settlement.

A second aspect of the present invention is a computerized method for order sharing among a plurality of customers at a commercial venue. The method comprises:
providing server-side functionality;
providing a plurality of customer mobile computing devices for use by said plurality of customers;
the server-side functionality managing a digital order;
the server-side functionality providing a network communication channel for the digital order;
the customer mobile computing devices communicating with the server-side functionality) using said network communication channel, by:
   a) the server-side functionality collectively sharing the digital order with the plurality of customer mobile computing devices;
   b) an individual customer mobile computing device requesting partial settlement of the digital order, where the partial settlement relates to any of:
      a partial payment of less than a total order value of all unsettled order items of the digital order, or
      payment of one or more, but less than all, unsettled order items of the digital order; and
c) the customer mobile computing devices receiving a collective update of the digital order from the server-side functionality to reflect the partial settlement.

A third aspect of the present invention is a computer program comprising program instructions for causing performance of the functionality of the customer mobile computing device in the method according to the second aspect when said program instructions are executed by a processing unit.

A fourth aspect of the present invention is a computer program comprising program instructions for causing performance of the functionality of a merchant computing device in embodiments of the method according to the second aspect (said embodiments being described in the following detailed description), when said program instructions are executed by a processing unit.

A fifth aspect of the present invention is a computer program comprising program instructions for causing performance of the functionality of the server-side functionality in the method according to the second aspect when said program instructions are executed by a processing unit.

Accordingly, the present invention provides a communication system, a computerized method and computer programs for order sharing among a plurality of customers at a commercial venue, all of which provide improvements over the prior art.

Still other aspects and features of the invention and its embodiments are defined by the appended patent claims and are further explained, together with problems solved and advantages obtained, in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings.

FIGS. 1A and 1B are schematic illustrations of order handling for a plurality of customers at a commercial venue according to the prior art.

FIG. 2 is a schematic illustration of a communication system for order sharing among a plurality of customers at a commercial venue in accordance with embodiments of the present invention.

FIGS. 3A and 3B illustrate how a network communication channel may be established in different exemplifying embodiments of the present invention.

FIGS. 4A and 4B illustrate collective sharing of real-time, or near real-time, information about the contents of a digital order over the network communication channel.

FIGS. 5A-5D illustrate partial settlement of the digital order using the network communication channel.

FIG. 6 is a flowchart diagram illustrating a computerized method for order handling for a plurality of customers at a commercial venue generally according to the invention.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

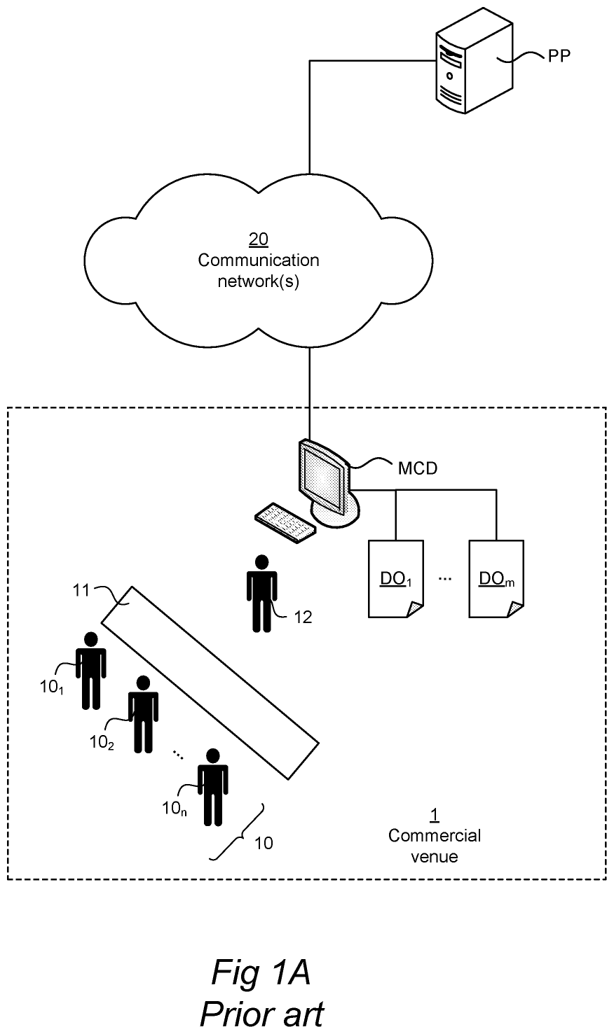

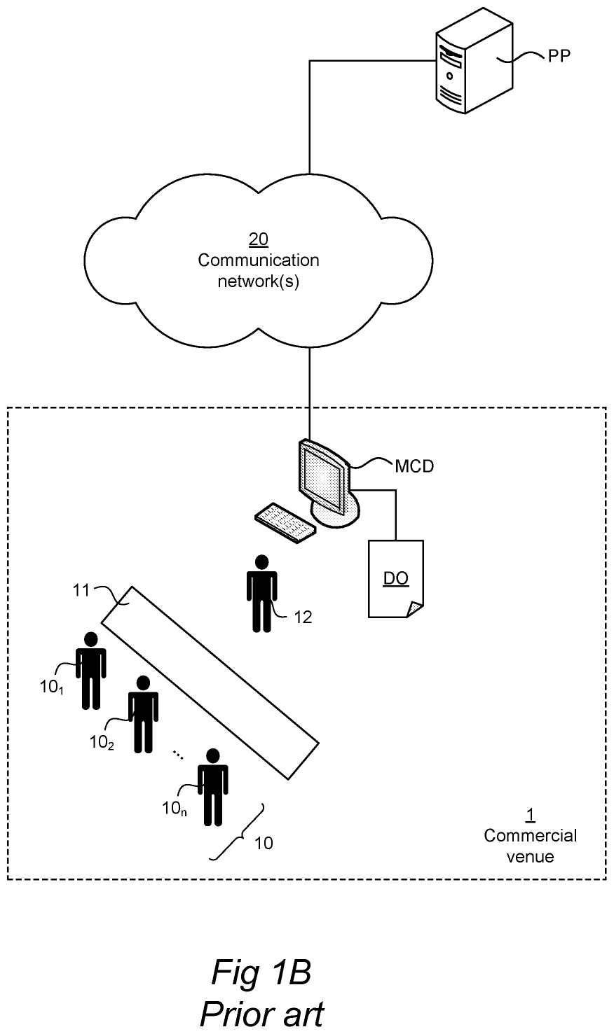

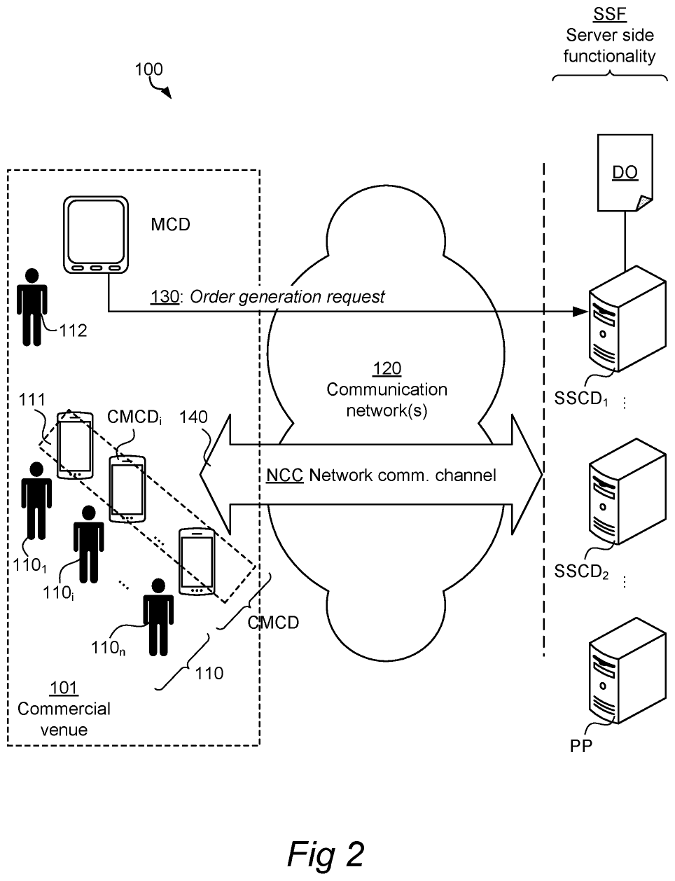

FIG. 2 schematically illustrates a communication system 100 for order sharing among a plurality of customers 110₁-110ₙ at a commercial venue 101, gathered at a spot 111 such as a table. Similar to the venue 1 in FIGS. 1A and 1B, the commercial venue 101 in FIG. 2 may, for instance, be a restaurant, bar, club, café, sport arena, concerts hall, theatre or cinema. In the forthcoming description, reference numeral 110 will be used when referring to the plurality of customers 110₁-110ₙ as a collective group. Reference numeral 110ᵢ will be used when referring to an individual customer among the plurality of customers 110.

Unlike the prior art referred to above for FIGS. 1A and 1B, the communication system 100 in FIG. 2 uses novel and inventive digital communication technology that allows the plurality of customers 110 to enjoy a shared real-time, or near real-time, sensation (or experience) of belonging to a single, unite group 110 which truly shares a digital order DO in the sense that all members of the plurality of customers 110 may follow the contents of the digital order DO throughout the visit at the commercial venue 101. To this end, each customer 110ᵢ uses a mobile computing device CMCDᵢ. As will be explained in more detail below, the shared real-time, or near real-time, sensation will in particular include also the stage where the digital order DO is to be settled by payment of different order items of the digital order.

The communication system 100 in FIG. 2 therefore comprises a plurality of customer mobile computing devices CMCD for use by the plurality of customers 110. Each customer mobile computing device CMCDᵢ is a mobile device, such as a mobile terminal, smartphone, tablet computer, personal digital assistant, notebook computer, smartwatch or smartglasses, having an operating system and a processing unit in the form of, for instance, one or more CPUs, DSPs, ASICs, FPGAs, etc. Each customer mobile computing device CMCDᵢ is programmed, i.e. configured, to perform its functionality as described in this document by the processing unit executing program instructions of a computer program.

The communication system 100 further comprises server-side functionality SSF. The server-side functionality SSF comprises one or more server-side computing devices SSCD. Each such server-side computing device SSCD is a server computer, a cluster of such server computers, or a cloud computing resource or service. The server-side computing device SSCD has a processing unit in the form of, for instance, one or more CPUs, DSPs, ASICs, FPGAs, etc., and is programmed, i.e. configured, to perform its functionality as described in this document by the processing unit executing program instructions of a computer program.

As seen in FIG. 2, a payment processor PP is also included in, or associated with, the communication system 100. The payment processor PP may be a computing device like a server computer, a cluster of such computer devices, or a cloud computing resource or service. It has a processing unit in the form of, for instance, one or more CPUs, DSPs, ASICs, FPGAs, etc., and is programmed, i.e. configured, to perform its functionality as described in this document by the processing unit executing program instructions of a computer program.

In some embodiments, the server-side computing device(s) SSCD and the payment processor PP may be implemented by the same server computer, cluster of such computer devices, or cloud computing resource or service. Hence, the server-side computing device(s) SSCD and the payment processor PPCD can be seen as different logical devices but not necessarily physically different devices.

The server-side functionality SSF is configured to manage a digital order DO. As is seen in FIG. 2, the digital order DO may be generated upon command by a merchant 112 (e.g. waiter/waitress), using a merchant computing device MCD to send an order generation request 130 to the server-side functionality SSF. The merchant computing device MCD may be a mobile device of a same or similar type as the customer mobile computing devices CMCD. Alternatively, the merchant computing device MCD may be a workstation computer, personal computer, laptop computer or cash register. The merchant computing device MCD has an operating system and a processing unit in the form of, for instance, one or more CPUs, DSPs, ASICs, FPGAs, etc. The merchant computing device MCD is programmed, i.e. configured, to perform its functionality as described in this document by the processing unit executing program instructions of a computer program.

The merchant 112 typically sends the order generation request 130 to the server-side functionality SSF when tending to the plurality of customers 110 for the first time, i.e. when wishing the plurality of customers 110 welcome to the venue 101 and asking them for their initial orderings.

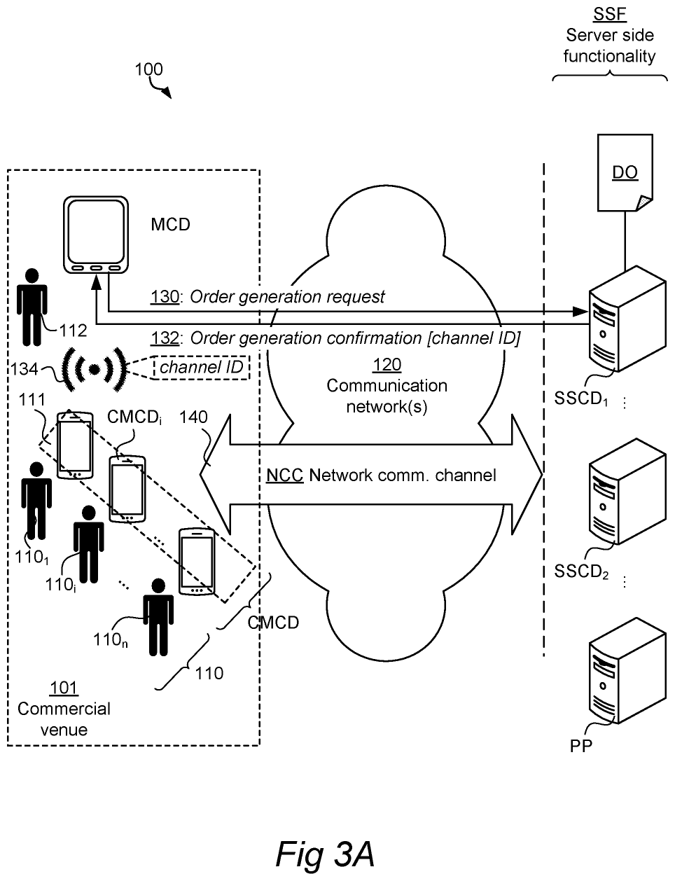

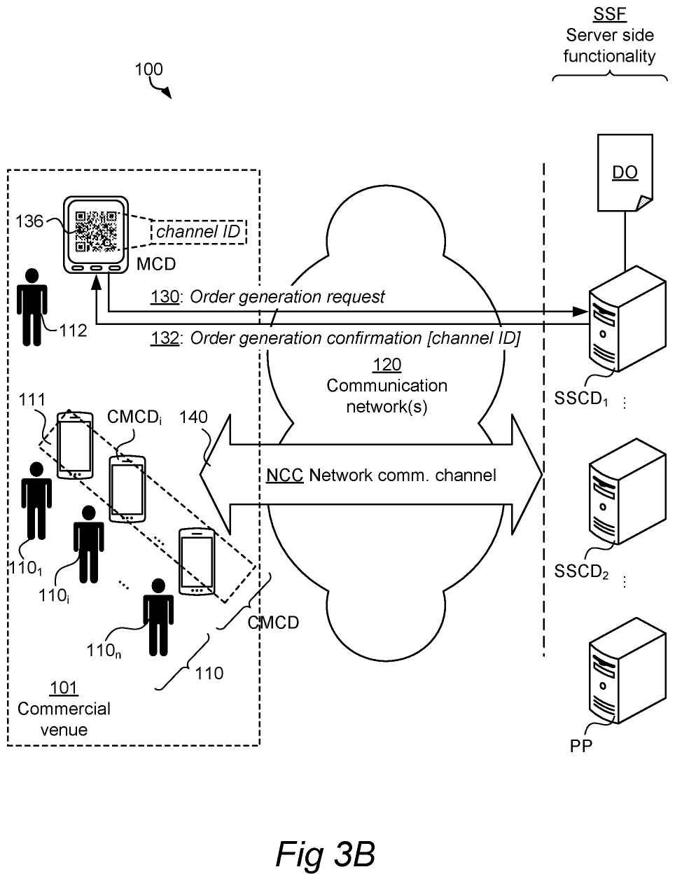

As a first key part of the present invention, the server-side functionality SSF is configured to provide a network communication channel NCC for the digital order DO over one or more communication networks 120. The one or more communication networks 120 may, for instance, be compliant with wireless communication pursuant to IEEE 802.11, IEEE 802.15, ZigBee, WirelessHART, WiFi, Bluetooth, WCDMA, HSPA, GSM, UTRAN, UMTS or LTE, or any combination thereof. The network communication channel NCC may, for instance, be implemented as TCP/IP communication. Particulars of the establishment of the network communication channel NCC will be described in more detail later with reference to FIGS. 3A and 3B.

As a second key part of the present invention, the customer mobile computing devices CMCD are configured for communication 140 with the server-side functionality SSF using the network communication channel NCC. The communication 140 includes at least the following functionalities.

Firstly, the server-side functionality SSF collectively shares the digital order

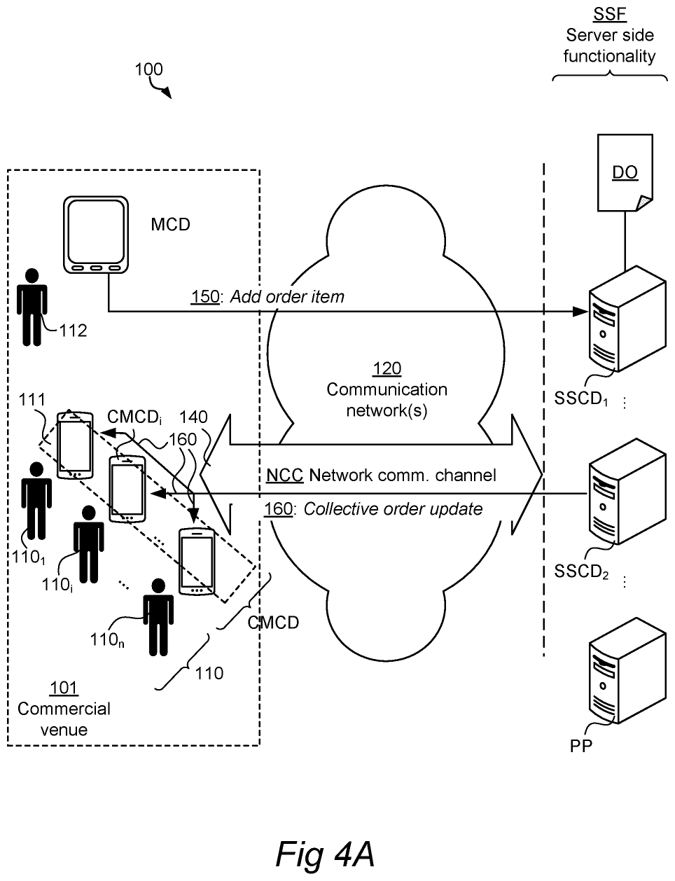

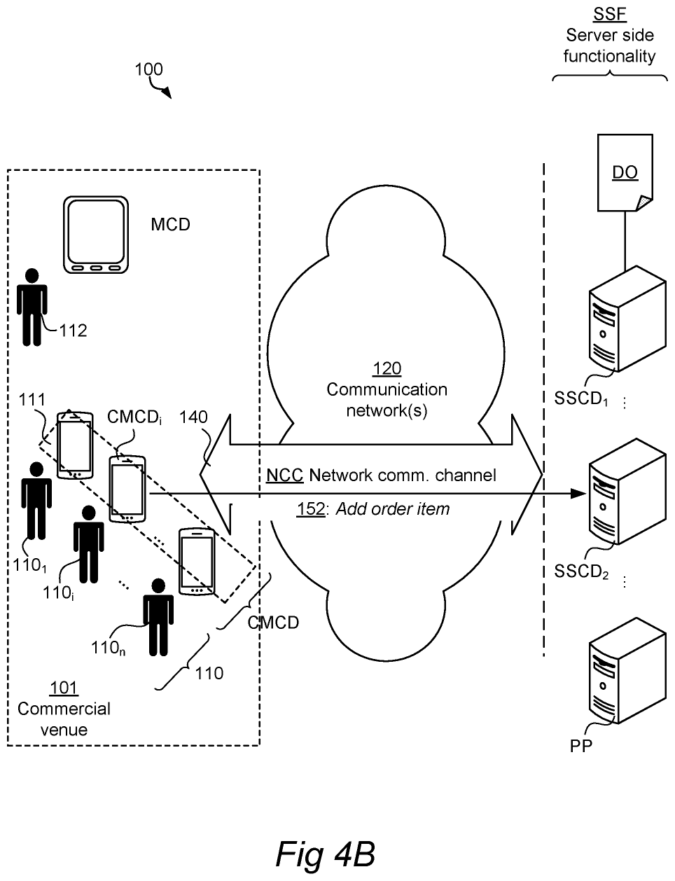

DO with the plurality of customer mobile computing devices CMCD using the network communication channel NCC. This means that the plurality of customers 110 may use their customer mobile computing devices CMCD to obtain real-time, or near real-time, information about the contents of the digital order DO throughout their stay at the commercial venue 101. This means that each customer 110ᵢ may be provided, in real-time, or near real-time, with information not only about the order items of the digital order DO that he or she has ordered, but in fact the order items ordered by all of the customers 110₁, . . . , 110ₙ of the plurality of customers 110. Particulars of the collective sharing of this real-time, or near real-time, information over the network communication channel NCC will be described in more detail later with reference to FIGS. 4A and 4B.

Secondly, an individual customer 110ᵢ may use his or her customer mobile computing device CMCDᵢ for requesting partial settlement of the digital order DO over the network communication channel NCC.

The partial settlement may relate to a partial payment of less than a total order value of all unsettled order items of the digital order DO. For example, the plurality of customers 110 may decide to split the digital order DO fair and square by each customer paying one n:th of the total order value, where n is the number of customers 110.

Alternatively, the partial settlement may relate to payment of one or more, but less than all, unsettled order items of the digital order DO. This may be the case when each customer 110ᵢ of the plurality of customers 110 shall pay specifically for his or her order items among all order items of the digital order DO.

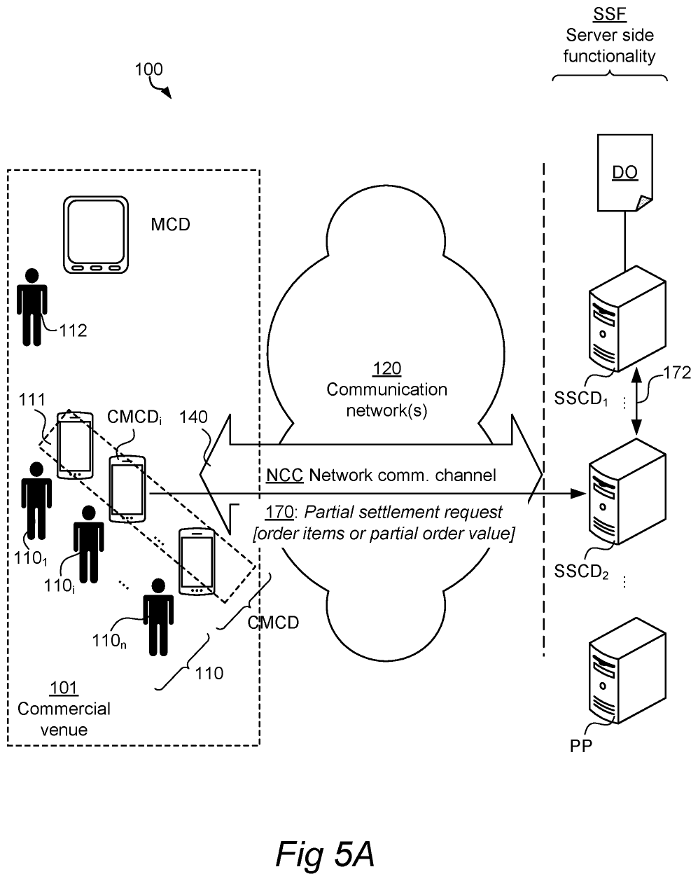

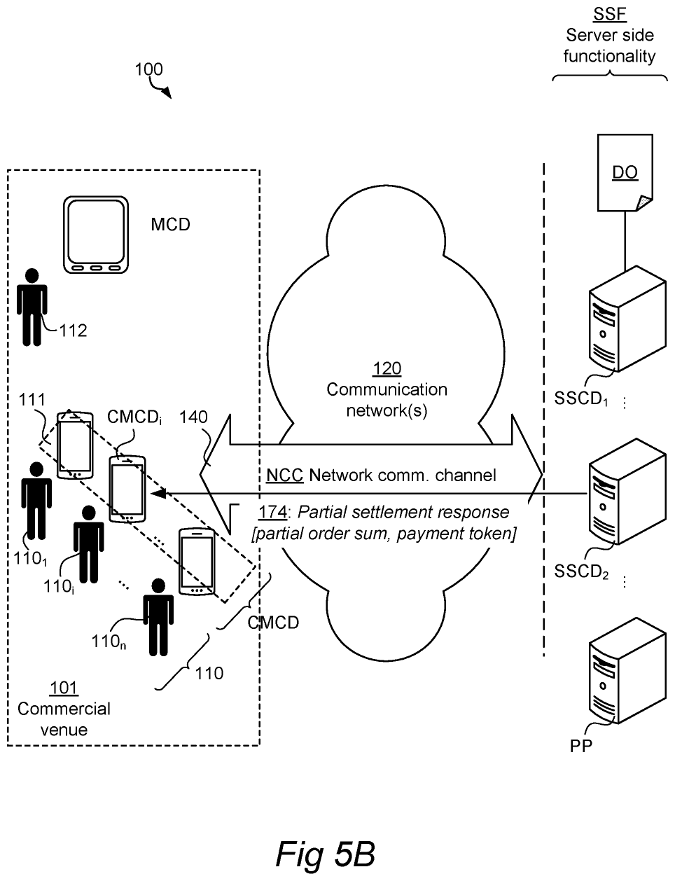

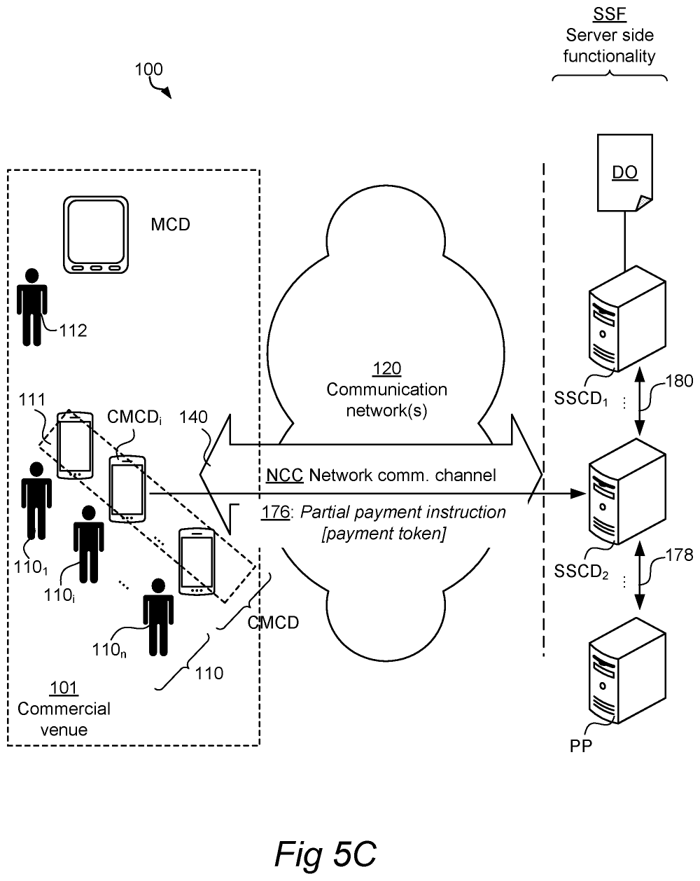

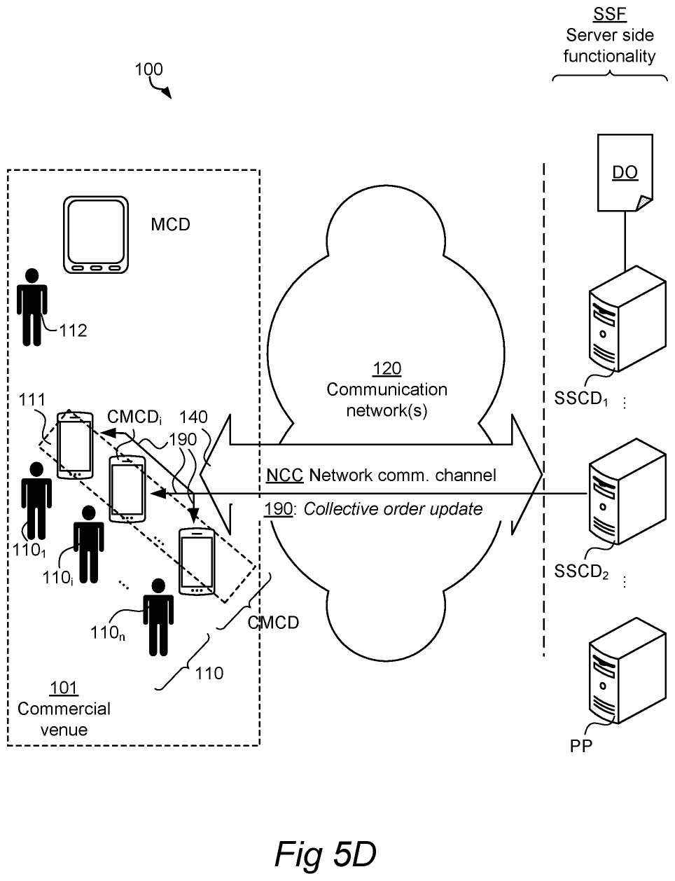

Particulars of the settlement stage will be described in more detail later with reference to FIGS. 5A-5D.

Thirdly, using the network communication channel NCC, the customer mobile computing devices CMCD will receive a collective update of the digital order DO from the server-side functionality SSF to reflect the executed partial settlement. This means that when a partial settlement of either a part of the total order value or some of the order items of the digital order DO is made, all customers 110 will be duly notified, in real-time, or near real-time, about this partial change in the settlement status of the digital order DO.

FIGS. 3A and 3B illustrate how the network communication channel NCC may be established in different exemplifying embodiments of the present invention. The merchant computing device MCD is configured for sending the order generation request 130 to the server-side functionality SSF. After having received the order generation request 130 and the digital order DO has been generated, the server-side functionality SSF sends an order generation confirmation 132 to the merchant computing device MCD. The order generation confirmation 132 contains channel identity information channel ID which serves to identify the network communication channel NCC to the customer mobile computing devices CMCD. The channel identity information channel ID is thus associated with the digital order DO. The merchant computing device MCD is further configured for receiving the order generation confirmation 132 from the server-side functionality SSF, and for making the received channel identity information channel ID available to the customer mobile computing devices CMCD.

In the embodiment illustrated in FIG. 3A, the merchant computing device MCD is configured for making the received channel identity information channel ID available to the customer mobile computing devices CMCD by transmitting the channel identity information channel ID in a wireless proximity signal 134. The wireless proximity signal 134 may, for instance, be a Bluetooth/Bluetooth Low Energy (BLE) signal, for instance a beacon-based signal pursuant to iBeacon, AltBeacon, Eddystone or UriBeacon. Other non-exhaustive alternatives include IEEE 802.11, IEEE 802.15, ZigBee, WirelessHART or WiFi.

In the embodiment of FIG. 3A, the customer mobile computing devices CMCD are configured for receiving the wireless proximity signal 134 and deriving the included channel identity information channel ID from the wireless proximity signal 134. The customer mobile computing devices CMCD are further configured for communicating 140 with the server-side functionality SSF using the network communication channel NCC as identified by the derived channel identity information channel ID.

In the alternative embodiment illustrated in FIG. 3B, the merchant computing device MCD is configured for making the received channel identity information channel ID available to the customer mobile computing devices CMCD by generating a graphical code 136 in which the received channel identity information channel ID is included. The merchant computing device MCD is further configured for presenting the generated graphical code 136, for instance on a display of the merchant computing device MCD, or alternatively using other available means capable of visual presentation of the generated graphical code 136 in a format which is perceivable by the customer mobile computing devices CMCD.

The generated graphical code 136 may, for instance, be a QR (Quick Response) code. Alternatively, the generated graphical code 136 may be another form of machine-readable optical code, for instance a one-dimensional barcode, such as a UPC (Universal Product Code) or EAN (European Article Number/International Article Number) code. Other alternatives may also exist, as would be clear to the skilled person, such as for instance a machine-readable three-dimensional barcode. Such a three-dimensional barcode may, for instance, be provided by means of a 3D printer to produce a code structure in three physical (spatial) dimensions. Still alternatively, a machine-readable three-dimensional barcode may be provided as a two-dimensional barcode having a third dimension in the form of, color or other additional machine-readable information. The current embodiment of the present invention is not limited to usage of any specific kind of machine-readable optical code for the generated graphical code 136.

In the embodiment of FIG. 3B, the customer mobile computing devices CMCD are configured for reading the graphical code 136 as presented by the merchant computing device MCD, and for deriving the channel identity information channel ID from the graphical code 136. The customer mobile computing devices CMCD are further configured for communicating 140 with the server-side functionality SSF using the network communication channel NCC as identified by the derived channel identity information channel ID.

In further alternative embodiments, the user of the customer mobile computing devices CMCD, i.e. the customers 110, may manually enter the channel identity information channel ID into their customer mobile computing devices CMCD when being prompted by the merchant 112 verbally or when being presented by the merchant computing device MCD.

FIGS. 4A and 4B illustrate collective sharing of real-time, or near real-time, information about the contents of the digital order DO over the network communication channel NCC. As seen in FIG. 4A, one or more order items may be added by the merchant 112 using the merchant computing device MCD. This may occur at the initial stage when the digital order DO is generated (i.e., in conjunction with the order generation request 130 which is sent when the merchant 112 asks the customers 110 for their initial orderings). It may also occur successively throughout the customers' 110 stay at the commercial venue 101 (i.e., when the merchant 112 receives additional orderings, such as another round of drinks or the ordering of desserts).

When an order item is to be added to the digital order DO, the merchant computing device MCD is configured for sending an add order item request 150 to the server-side functionality SSF. When the order item has been added to the digital order

DO, the server-side functionality SSF is configured for collective sharing of the contents of the digital order DO by conveying a collective order update 160 to all customer mobile computing devices CMCD being able to “listen” to the network communication channel NCC. Thus, the collective order update 160 will be conveyed on the network communication channel NCC as identified by the channel identity information channel ID associated with the digital order DO.

The collective order update 160 may be conveyed in a “push” manner, such that the server-side functionality SSF will automatically notify the customer mobile computing devices CMCD which are listening to the network communication channel NCC (as identified by the channel identity information channel ID associated with the digital order DO) as soon as any update is made to the digital order DO.

Alternatively, the collective order update 160 may be conveyed in a “pull” manner, such that the customer mobile computing devices CMCD which are listening to the network communication channel NCC (as identified by the channel identity information channel ID associated with the digital order DO) will repeatedly poll the server-side functionality SSF for any updates to the digital order DO.

FIG. 4B illustrates an alternative embodiment in which the customer mobile computing devices CMCD (rather than the merchant computing device MCD) are configured for individually placing order items to be added to the digital order DO managed by the server-side functionality SSF. An individual CMCDᵢ uses the network communication channel NCC for sending an add order item request 152 to the server-side functionality SSF. When the order item has been added to the digital order DO, the server-side functionality SSF is configured for collective sharing of the contents of the digital order DO by conveying a collective order update to all customer mobile computing devices CMCD being able to “listen” to the network communication channel NCC. This is not illustrated explicitly in FIG. 4B, but it occurs much like the collective order update 160 described above for FIG. 4A.

Generally, the server-side functionality SSF collectively sharing the digital order DO with the plurality of customer mobile computing devices CMCD may involve conveying collective order updates 160 on the network communication channel NCC. The collective order updates 160 may pertain to one or more of the following:
addition 150, 152 of order items to the digital order DO,
cancellation of order items from the digital order DO,
modification of order items of the digital order DO,
payments for unsettled order items of the digital order DO,
partial payments of less than a total order value of all unsettled order items of the digital order DO,
joining of new customer mobile computing devices CMCD being able to receive collective order updates 160 on the network communication channel NCC, and
resignation of existing customer mobile computing devices CMCD being able to receive collective order updates 160 on the network communication channel NCC.

5A-5D illustrate partial settlement of the digital order DO using the network communication channel NCC.

As shown in FIG. 5A, an individual customer mobile computing device CMCDᵢ uses the network communication channel NCC to make a request 170 for partial settlement of the digital order DO. As already discussed, the partial settlement may relate to a partial payment of less than a total order value of all unsettled order items of the digital order DO. Alternatively, as has also been discussed, the partial settlement may relate to payment of one or more, but less than all, unsettled order items of the digital order DO. The server-side functionality SSF makes internal preparations 172 for handling the request 170 for partial settlement.

As seen in FIG. 5B, the server-side functionality SSF uses the network communication channel NCC for sending a partial settlement response 174 to the requesting individual customer mobile computing device CMCDᵢ. The partial settlement response 174 will include relevant data, such as a partial order sum to be paid by the individual customer mobile computing device CMCDᵢ, and a payment token to be used for the payment procedure.

The individual customer 110ᵢ in possession of the individual customer mobile computing device CMCDᵢ may check the received partial settlement response 174 and the data included therein. Upon approval, the individual customer mobile computing device CMCDᵢ uses the network communication channel NCC for sending a partial payment instruction 176 to the server-side functionality SSF. This can be seen in FIG. 5C. The payment token is preferably included in the partial payment instruction 176 and is used by the server-side functionality SSF to execute a payment transaction with the payment processor PP, as seen at 178. The payment transaction may, for instance, be a credit card transaction or another type of electronic payment transaction. Moreover, the server-side functionality SSF also updates the digital order DO to reflect the partial settlement of the order items thereof, as seen at 180.

As seen in FIG. 5D, using the network communication channel NCC, the server-side functionality SSF sends a collective update 190 of the digital order DO to the customer mobile computing devices CMCD. This is done in much the same way as the collective update 160 described above with reference to FIG. 4A.

Accordingly, the customer mobile computing devices CMCD will receive the collective update 190 of the digital order DO from the server-side functionality SSF to reflect the partial settlement. Hence, the customers 110 of the customer mobile computing devices CMCD will benefit from a real-time, or near real-time, update of the current contents of the digital order DO.

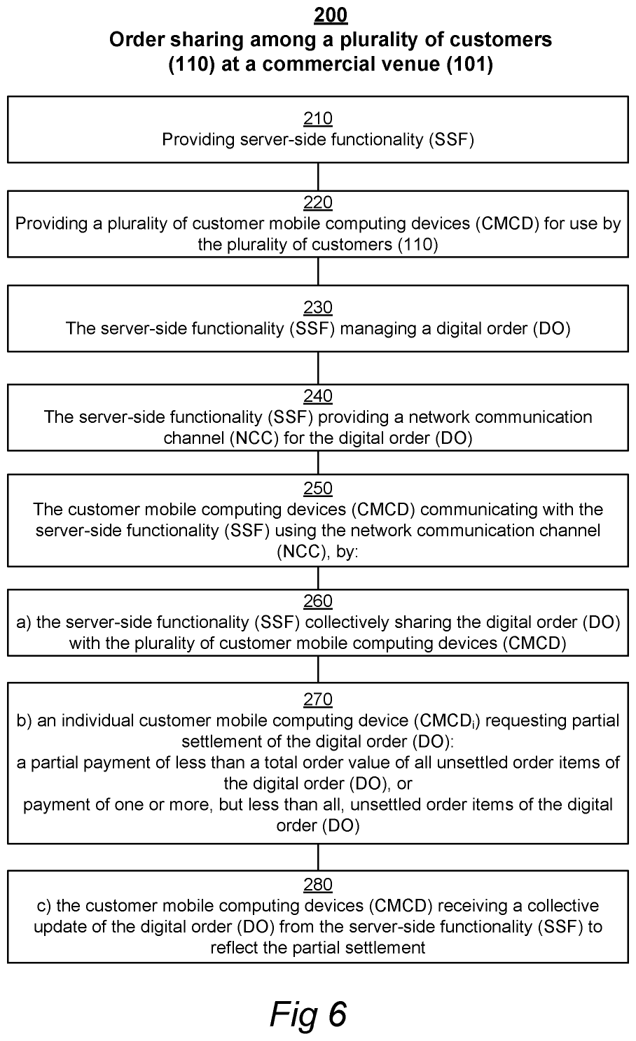

Reference is now made to FIG. 6 which is a flowchart diagram illustrating a computerized method 200 for order sharing among a plurality of customers 110 at a commercial venue 101 generally according to the invention.

In a first step 210, server-side functionality SSF is provided, as discussed above. Likewise, a second step 220 provides a plurality of customer mobile computing devices CMCD for use by the plurality of customers 110.

In a third step 230, as previously discussed, the server-side functionality SSF manages a digital order DO.

In a fourth step 240, the server-side functionality SSF provides a network communication channel NCC for the digital order DO; again, this has been discussed above.

Likewise, in a fifth step 250, the customer mobile computing devices CMCD communicate with the server-side functionality SSF using the network communication channel NCC. The communication in step 250 comprises three sub-steps 260, 270 and 280, the functionalities of which have already been discussed above.
a) In sub-step 260, the server-side functionality SSF collectively shares the digital order DO with the plurality of customer mobile computing devices CMCD.
b) In sub-step 270, an individual customer mobile computing device CMCDᵢ requests partial settlement of the digital order (DO), where the partial settlement relates to any of:
   a partial payment of less than a total order value of all unsettled order items of the digital order DO, or
   payment of one or more, but less than all, unsettled order items of the digital order DO.
c) In sub-step 280, the customer mobile computing devices CMCD receives a collective update of the digital order DO from the server-side functionality SSF to reflect the partial settlement.

As a skilled person will directly and unambiguously understand from the description, claims and drawings of this document, the term “network communication channel” (NCC in abbreviation) is to be understood as the access to a digital order DO that the server-side functionality SSF provides to the customer mobile computing devices CMCD by way of communication over a data communication network 120. Moreover, the skilled person will directly and unambiguously understand the term “channel identity information” (channel ID) as information in the form of an identifier, address, indicator, etc, being used by the server-side functionality SSF and the customer mobile computing devices CMCD in the communication over the data communication network when accessing the particular digital order DO, the channel identity information channel ID thus serving to identify the network communication channel NCC and, therefore, also the particular digital order DO.

The channel identity information channel ID may be provided to the customer mobile computing devices CMCD in any of the ways discussed above. The customer mobile computing devices CMCD will use the channel identity information channel ID to “tune in” to the network communication channel NCC by way of communication over the data communication network 120 with the server-side functionality SSF, for instance to receive a collective update of the digital order DO reflecting a partial settlement made by one of the customer mobile computing devices CMCD, or to receive a collective update of the digital order DO as one or more order items have been added to the digital order DO.

The invention has been described above in detail with reference to embodiments thereof. However, as is readily understood by those skilled in the art, other embodiments are equally possible within the scope of the present invention, as defined by the appended claims. The invention is defined in its broadest sense by appended independent claims. Advantageous embodiments are defined by the appended dependent claims.

One such advantageous embodiment is defined by the features of the appended claims 1 and 2 in combination. Another advantageous embodiment is defined by the features of the appended claims 1, 2 and 4 in combination. Still another advantageous embodiment is defined by the features of the appended claims 1, 2, 4 and 5 in combination. Yet another advantageous embodiment is defined by the features of the appended claims 1, 2, 4 and 6 in combination. These are however not the only advantageous embodiments conceivable.

1. A communication system for order sharing among a plurality of customers at a commercial venue, the communication system comprising:
server-side functionality; and
a plurality of customer mobile computing devices for use by the plurality of customers;
wherein the server-side functionality is configured to manage a digital order;
wherein the server-side functionality is configured to provide a network communication channel for the digital order;
wherein the customer mobile computing devices are configured for communication with the server-side functionality using the network communication channel, the communication including,
a) the server-side functionality collectively sharing the digital order with the plurality of customer mobile computing devices;
b) an individual customer mobile computing device requesting partial settlement of the digital order, where the partial settlement relates to any of,
a partial payment of less than a total order value of all unsettled order items of the digital order, or
a payment of one or more, but less than all, unsettled order items of the digital order; and
c) the customer mobile computing devices receiving a collective update of the digital order from the server-side functionality to reflect the partial settlement.

2. The communication system as defined in claim 1, wherein the customer mobile computing devices are configured for:
receiving a wireless proximity signal;
deriving channel identity information from the wireless proximity signal; and
communicating with the server-side functionality using the network communication channel as identified by the derived channel identity information.

3. The communication system as defined in claim 1, wherein the customer mobile computing devices are configured for:
reading a graphical code;
deriving channel identity information from the graphical code; and
communicating with the server-side functionality using the network communication channel as identified by the derived channel identity information.

4. The communication system as defined by claim 1, further comprising a merchant computing device configured for:
sending an order generation request to the server-side functionality;
receiving an order generation confirmation from the server-side functionality wherein the order generation confirmation contains channel identity information which serves to identify the network communication channel; and
making the received channel identity information available to the customer mobile computing devices.

5. The communication system as defined in claim 4,
wherein the customer mobile computing devices are configured for
receiving a wireless proximity signal
deriving the channel identity information from the wireless proximity signal, and
communicating with the server-side functionality using the network communication channel as identified by the derived channel identity information; and
wherein the merchant computing device is configured to make the received channel identity information available to the customer mobile computing devices by transmitting the channel identity information in the wireless proximity signal.

6. The communication system as defined in claim 4,
wherein the customer mobile computing devices are configure for
reading a graphical code,
deriving the channel identity information from the graphical code, and
communicating with the server-side functionality using the network communication channel as identified by the derived channel identity information; and
wherein the merchant computing device is configured for making the received channel identity information available to the customer mobile computing devices by
generating the graphical code, wherein the received channel identity information is included in the generated graphical code; and
presenting the generated graphical code by means of the merchant computing device.

7. The communication system as defined in claim 1, further comprising:
i) a merchant computing device being configured for placing order items to be added to the digital order managed by the server-side functionality; and
ii) the customer mobile computing devices being configured for receiving collective updates of the digital order from the server-side functionality as order items are added to the digital order.

8. The communication system as defined in claim 1, further comprising:
i′) using the network communication channel, the customer mobile computing devices being configured for individually placing order items to be added to the digital order managed by the server-side functionality; and
ii) the customer mobile computing devices being configured for receiving collective updates of the digital order from the server-side functionality as order items are added to the digital order.

9. The communication system as defined in claim 1, wherein the server-side functionality is configured for collectively sharing the digital order with the plurality of customer mobile computing devices by conveying collective order updates on the network communication channel, the collective order updates pertaining to one or more of the following:
addition of order items to the digital order,
cancellation of order items from the digital order,
modification of order items of the digital order,
payments for unsettled order items of the digital order,
partial payments of less than a total order value of all unsettled order items of the digital order,
joining of new customer mobile computing devices being able to receive collective order updates on the network communication channel, and
resignation of existing customer mobile computing devices being able to receive collective order updates on the network communication channel.

10. A computerized method for order sharing among a plurality of customers at a commercial venue, the method comprising:
providing server-side functionality;
providing a plurality of customer mobile computing devices for use by the plurality of customers;
the server-side functionality managing a digital order;
the server-side functionality providing a network communication channel for the digital order;
the customer mobile computing devices communicating with the server-side functionality using the network communication channel by,
a) the server-side functionality collectively sharing the digital order with the plurality of customer mobile computing devices;
b) an individual customer mobile computing device requesting partial settlement of the digital order, where the partial settlement relates to any of,
a partial payment of less than a total order value of all unsettled order items of the digital order, or
payment of one or more, but less than all, unsettled order items of the digital order; and
c) the customer mobile computing devices receiving a collective update of the digital order from the server-side functionality to reflect the partial settlement.

11. The computerized method as defined in claim 10, further comprising the customer mobile computing devices:
receiving a wireless proximity signal;
deriving channel identity information from the wireless proximity signal; and
communicating with the server-side functionality using the network communication channel as identified by the derived channel identity information.

12. The computerized method as defined in claim 10, further comprising the customer mobile computing devices:
reading a graphical code;
deriving channel identity information from the graphical code; and
communicating with the server-side functionality using the network communication channel as identified by the derived channel identity information.

13. The computerized method as defined in claim 10, further comprising:
providing a merchant computing device;
the merchant computing device sending an order generation request to the server-side functionality;
the merchant computing device receiving an order generation confirmation from the server-side functionality, wherein the order generation confirmation contains channel identity information which serves to identify the network communication channel; and
the merchant computing device making the received channel identity information available to the customer mobile computing devices.

14. The computerized method as defined in claim 13, further comprising the customer mobile computing devices:
receiving a wireless proximity signal;
deriving the channel identity information from the wireless proximity signal; and
communicating with the server-side functionality using the network communication channel as identified by the derived channel identity information;
wherein the merchant computing device makes the received channel identity information available to the customer mobile computing devices by transmitting the channel identity information in the wireless proximity signal.

15. The computerized method as defined in claim 13, further comprising the customer mobile computing devices;
reading a graphical code;
deriving the channel identity information from the graphical code; and
communicating with the server-side functionality using the network communication channel as identified by the derived channel identity information;
wherein the merchant computing device makes the received channel identity information available to the customer mobile computing devices by,
generating the graphical code, wherein the received channel identity information is included in the generated graphical code, and
presenting the generated graphical code by means of the merchant computing device.

16. The computerized method as defined in claim 10, further comprising:
i) a merchant computing device placing order items to be added to the digital order managed by the server-side functionality; and
ii) the customer mobile computing devices receiving collective updates of the digital order from the server-side functionality as order items are added to the digital order.

17. The computerized method as defined in claim 10, further comprising:
i′) using said network communication channel, the customer mobile computing devices individually placing order items to be added to the digital order managed by the server-side functionality; and
ii) the customer mobile computing devices receiving collective updates of the digital order from the server-side functionality as order items are added to the digital order.

18. The computerized method as defined in claim 10, wherein step a) of the server-side functionality collectively sharing the digital order with the plurality of customer mobile computing devices involves conveying collective order updates on the network communication channel, wherein the collective order updates pertain to one or more of the following:
addition of order items to the digital order,
cancellation of order items from the digital order,
modification of order items of the digital order,
payments for unsettled order items of the digital order,
partial payments of less than a total order value of all unsettled order items of the digital order,
joining of new customer mobile computing devices being able to receive collective order updates on the network communication channel, and
resignation of existing customer mobile computing devices being able to receive collective order updates on the network communication channe1.

19. A computer program comprising program instructions for causing performance of the functionality of the customer mobile computing device in the method according to claim 10 when the program instructions are executed by a processing unit.

20. A computer program comprising program instructions for causing performance of the functionality of the merchant computing device in the method according to claim 13 when the program instructions are executed by a processing unit.

21. A computer program comprising program instructions for causing performance of the functionality of the server-side functionality in the method according to claim 10 when the program instructions are executed by a processing unit.
